(19) United States
(12) Patent Application Publication
(10) Pub. No.: US 2007/0074081 A1
(43) Pub. Date: Mar. 29, 2007

(54) Method and apparatus for adjusting profiling rates on systems with variable processor frequencies

(76) Inventors: Jimmie Earl DeWitt JR., Georgetown, TX (US); Frank Levine, Austin, TX (US); Enio Manuel Pineda, Austin, TX (US); Robert John Urquhart, Austin, TX (US)

Correspondence Address: IBM CORP (YA);C/O YEE & ASSOCIATES PC, P.O. BOX 802333, DALLAS, TX, 75380, US

(21) Appl. No.: 11/239,503

(22) Filed: Sep. 29, 2005

(51) Int. Cl. G06F 11/00

(52) U.S. Cl. 714/45

(57) ABSTRACT

A computer implemented method, apparatus, and computer usable program code for adjusting rates at which events are generated or processed. In response to a frequency change in a processor, a frequency for the processor is identified. A rate at which samples of events generated by the processor are selected to meet a desired rate of sampling is adjusted in response to identifying the frequency change for the processor to form an adjusted rate.

### BACKGROUND OF THE INVENTION

1. Field of the Invention

The present invention relates generally to an improved data processing system and in particular to a computer implemented method and apparatus for processing data. Still more particularly, the present invention relates to a computer implemented method, apparatus, and computer usable program code for adjusting the rates of occurrences of performance monitoring events before generating interrupts.

2. Description of the Related Art

In order to reduce heat and power consumption, a data processing system may change the frequency of one or more processors. Alternatively, different processors in the same data processing system may have different fixed frequencies. The dynamic frequency changes may be caused by a variety of reasons. For example, a detection of overheating or excessive power consumption may cause a reduction in frequency in one or more processors. Additionally, a desire to reduce power consumption in a portable data processing system, such as a laptop, is another reason for changing frequencies based on usage. Other conditions also may cause changes in processor frequencies. The conditions requiring changes in processor frequency also may be caused by application specific characteristics. As an example, a program that uses different components of a processor at the same time, may increase the heating and power consumption. In some cases, changes in processor frequencies may be based upon information about an application. For example, having knowledge that an application has a large number of cache misses may cause a lowering of processor frequency to reduce power since the overall performance may only be minimally affected due to the waiting for those cache misses.

The presently used algorithms and programs for identifying hot spots in a program are biased because the changes or the assignment of an application to a processor may not be random. The frequency change in processors during the operation of a data processing system increases difficulty in tracing events. Typically, separate processor buffers are used to record trace events. A trace record contains information or data about an event that occurs during a trace. The trace records stored in a buffer are referred to as a trace.

The performance characteristics of a data processing system can be identified using a software performance analysis tool. These may be based on a trace facility, or trace system. A trace tool may be used for more than one technique to provide trace information that indicates execution flows for an executing program. A trace may contain data about the execution of code. For example, a trace may contain trace records about events generated during the execution of the code. A trace may include information, such as, a process identifier, a thread identifier, and a program counter. Information in a trace may vary depending on a particular profile or analysis that is to be performed. A record is a unit of information relating to an event.

### SUMMARY OF THE INVENTION

The aspects of the present invention provide a computer implemented method, apparatus, and computer usable program code for adjusting rates at which events are generated or processed. In response to a frequency change in a processor, a frequency for the processor is identified. A rate at which samples of events generated by the processor are selected to meet a desired rate of sampling is adjusted in response to identifying the frequency change for the processor to form an adjusted rate.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system shown in which aspects of the present invention may be implemented;

FIG. 3 is a diagram illustrating components used in generating and processing traces in accordance with an illustrative embodiment of the present invention;

FIG. 4 is an example trace in accordance with an illustrative embodiment of the present invention;

FIG. 5 is a diagram illustrating a frequency change record in accordance with an illustrative embodiment of the present invention;

FIG. 6 is a diagram for pseudo code for reading elapsed time simultaneously on processors in accordance with an illustrative embodiment of the present invention;

FIG. 7 is a flowchart of a process for adjusting samples taken during the execution of code in accordance with an illustrative embodiment of the present invention;

FIG. 8 is a flowchart of a process used to adjust sampling of events from completed traces in accordance with an illustrative embodiment of the present invention; and

FIG. 9 is a flowchart of a process for prorating events after the completion of a trace in accordance with an illustrative embodiment of the present invention.

### DETAILED DESCRIPTION OF THE PREFERRED EMBODIMENT

With reference now to the figures and in particular with reference to FIG. 1, a pictorial representation of a data processing system in which the aspects of the present invention may be implemented. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

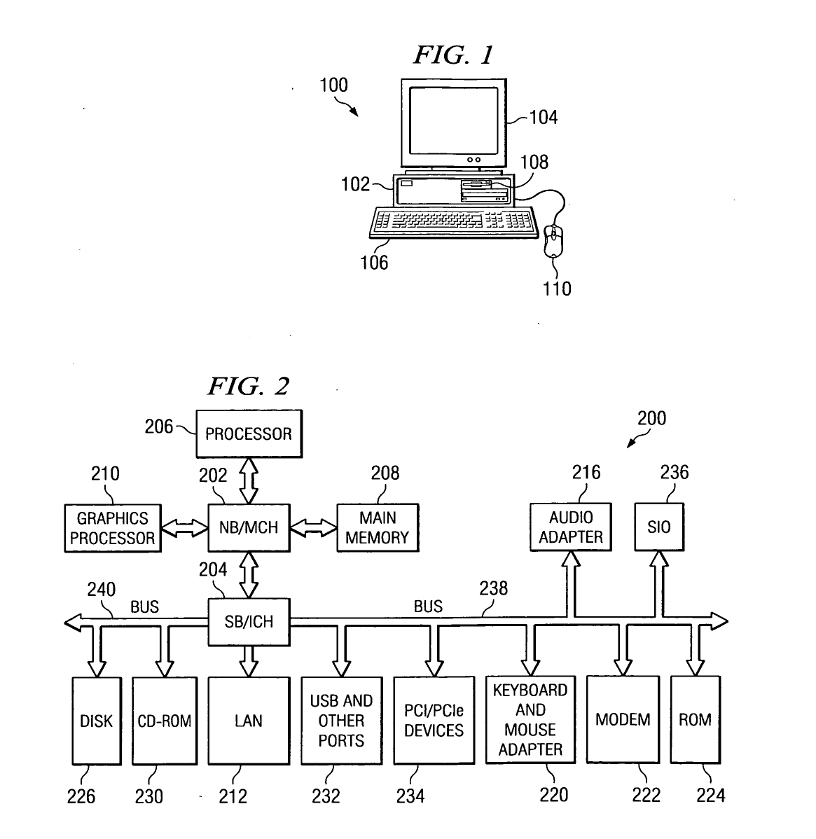

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for automatically adjusting profiling rates on systems with variable processor frequencies. The aspects of the present invention may be applied to adjust profiling rates either after the traces have been completed or during generation of the traces. A profiling rate is a rate at which samples or events are collected for analysis. In addition, the aspects of the present invention recognize that in determining hot spots in applications with multiple processors that have variable processor frequencies, a cycle time profiling tool may be used to compensate for the change in processor frequencies.

Further, the aspects of the present invention also recognize that statistical information may be present to relate specific performance counter events in a processor to a specific processor speed. The technique for gathering this statistical information in these examples is to collect this data and to add the information to a database. In one embodiment, the statistical database may be indexed by event type, and under the event type, by processor frequency. In another embodiment, the statistical database may be indexed by processor frequency and then by event type. The administrator could be responsible for identifying when to collect the data to be added to the database. As an example, suppose that cycles are being used as a performance counter event. Then, if the frequency of the processor is reduced by 50 percent, the number of cycles is reduced to 50 percent before taking the next interrupt to compensate for the change of frequency. Similarly, other events, such as, the number of instructions completed are expected to be reduced as well as most other events as the processor is running at a slower rate. If the cycle rate increases, the rate of occurrences of most events is expected to increase. If the reason for reducing the frequency is due to knowing that a lot of cache misses are present for a given application, then the reduction in number of completed instructions may be much lower than the reduction in frequency. As an example, the reduction in frequency by 50 percent may only cause a 10 percent reduction in completed instructions.

The aspects of the present invention also recognize that if time profiling is related to bus speed, then the tick rate is independent of the processor frequency and no need would be present for the processes of the present invention. However, if the interrupt rate is controlled by processor cycles; that is, the interrupt rate is set to processor cycles through selecting a performance counter in a processor and setting the event in the counter to cycles, then the aspects of this embodiment of the present invention are needed. A performance counter is a register, which may count occurrences of selected events occurring in a processor. These events may be, for example, a cache miss, a branch instruction, a stall in a cache, or a floating-point operation. The different aspects of the present invention identify the frequency of the processors, receive interrupts from frequency changes, and compensate for the sampling rate for the processors.

If statistical information is available concerning specific counter events, similar algorithms may be applied to normalize the reports. Further, the rates of events may be detected and changed to be consistent across different processors. Finally, the sampling rate may be adjusted as information is gathered about the sampling rates that occur during the generation of the trace.

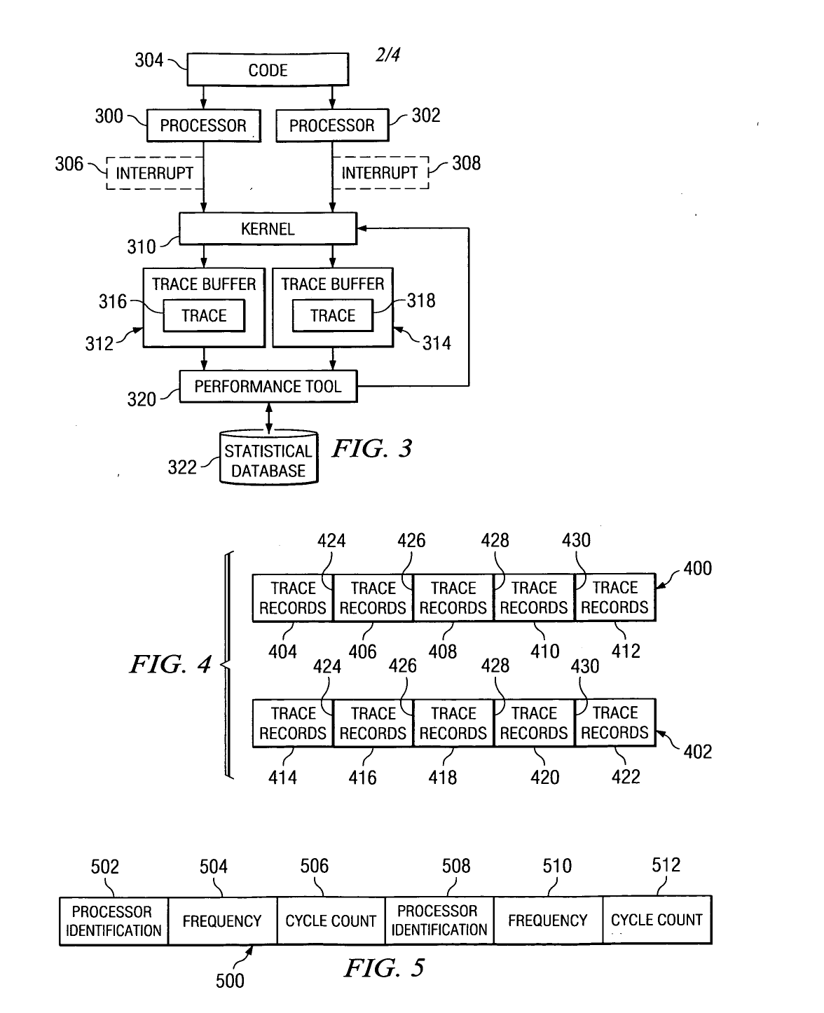

Turning now to FIG. 3, a diagram illustrating components used in generating and processing traces is depicted in accordance with an illustrative embodiment of the present invention. In this example, processor 300 and processor 302 execute code 304. Interrupts 306 and 308 are generated by processors 300 and 302 respectively. These interrupts are received by kernel 310 and trace records are stored within trace buffers 312 and 314. In these examples, each processor is assigned a separate trace buffer. As a result, interrupt 306 results in data being stored in trace 316 within trace buffer 312 for processor 300. Interrupt 308 causes a trace record or other data to be stored in trace 318 within trace buffer 314 for processor 302.

In these examples, interrupt 306 and interrupt 308 are interrupts generated by occurrences of events. In particular, these events are events that are identified and tracked by counters in a processor. Interrupt 306 and interrupt 308 also may be generated as a result of a frequency change. These types of interrupts are called frequency change records. These frequency change records also are stored within trace buffer 312 and trace 316 in these illustrative examples.

Performance tool 320 may be implemented using a timer profiler in these depicted embodiments. An example of this type of tool is the tprof tool, typically shipped with Advance Interactive Executive (AIX™) operating system from International Business Machines Corporation. This type of program takes samples, which are initiated by a timer generating an interrupt. Upon expiration of a timer, the tprof tool identifies the current instruction being executed. The tprof tool is a trace tool used in system performance analysis. This type of tool provides a sampling technique encompassing the following steps: interrupt the system periodically by time; determine the address of the interrupted code along with the process identifier and thread identifier; record a trace record in a software trace buffer; and return to the interrupted code.

In typical use, while running an application of interest, a tprof trace tool wakes up periodically and records exactly where in the code the application is executing. For example, this location of where the application is executing is a memory address. This tprof tool is used to generate a profile of where an application is spending time to inform those analyzing the trace information where to attempt improvements in performance of the application. Of course, performance tool 320 may be implemented using any sort of performance tool based on a particular implementation. This type of performance tool also may be used to collect and analyze the traces. During the time the application tprof is running, modules or code, such as JITed code (i.e. just-in-time compiled) may be loaded, unloaded, or overlayed. In order to produce the correct symbolic information, the information regarding the loading or unloading may be recorded in one or more of the trace buffers. In order for the symbolic information to be correct, it is important that the ordering of the information of the loaded modules be used to determine the symbolic information applicable to a tprof sample trace record.

In one aspect of the present invention, performance tool 320 initially sets a sampling rate for events generated by processors 300 and 302. In other words, performance tool 320 may require 100 samples per second. Performance tool 320 may query statistical database 322 to obtain information for the particular event that is being sampled through the interrupts. If the statistical data indicates that for this particular type of event, 100,000 events occur per second, the desired sampling rate would be to sample or store one sample every 1,000 events.

As a result, performance tool 320 sends a signal or call to kernel 310 to generate an interrupt and thus a trace record for every 1,000 events detected by the performance monitoring component of processor 300. A similar process is performed for the type of event for processor 302 based on the frequency of processor 302. The frequency of processor 300 is identified and used to determine the number of events expected for the particular type of event.

In this type of implementation, when a frequency change record is generated, performance tool 320 may re-adjust the sampling rate based on the expected occurrence of events for the new frequency for the particular type of event.

In another illustrative embodiment, all of the samples are collected and stored in trace 316 and trace 318. The samples used are adjusted after the traces have been completed in this particular example. Performance tool 320 identifies the frequencies of the processor at the start of the traces. As illustrated, for trace 316, sampling rate is calculated for the desired samples within a period of time. The desired samples within a period of time is the desired sampling rate in this example. In this example, the rate of events used by performance tool 320 is adjusted to be consistent across the different processors for different frequencies. For example, this change is made such that the samples are taken at the same time between events. For example, if the expected occurrence of events for a particular frequency is 100,000 events per second, and the desired sampling rate is 100 events per second, then performance tool 320 sets the performance monitor to cause an interrupt after 1,000 events have occurred. In an alternative embodiment, the interrupt handler may instead only produce trace request for one sample out of every 1,000 samples or events recorded within the traces for that particular frequency. This selection of samples from the trace occurs until a frequency change record is encountered in trace 316. In a further embodiment, the post processing code may only use the trace data after 1,000 events have occurred.

When a new frequency is identified in trace 316, the expected occurrence of events is identified for that particular frequency and the particular type of event using statistical database 322. At this time, performance tool 320 selects a new number of event occurrences to generate the interrupt to get a different number of samples. Alternatively, if the particular frequency results in 10,000 events per second with the 100 samples per second sampling rate, then one sample is selected from every 100 samples in the traces for use in analysis. This selection of samples occurs until another frequency change record is encountered in the traces. The process is then repeated to identify which samples to select for use in analysis. Trace 318 also is processed in this manner.

This post processing aspect of the present invention involves identifying the frequency and the type of event. Performance tool 320 queries statistical database 322 to identify the expected occurrence of events for that frequency. Based on the expected events per second, the desired sampling rate may be used to identify the number of event occurrences to select for processing.

In yet another aspect of the present invention, performance tool 320 prorates the rates of each sample within trace 316 and trace 318 based on the ratio of processor frequencies. As a result, some samples may be given more weight than other samples.

In particular, the samples in trace 316 and trace 318 may be weighted. The weighting is based on the ratio of processor frequencies in these examples. The compensation is based on the current ratio processor frequencies. For example, at the beginning of a trace, such as trace 316, when a frequency change of a processor occurs, the sampling rates are adjusted to the same number of samples per second for each processor. In this example, if processor 1 is one gigahertz, processor 2 is two gigahertz, and processor 3 is three gigahertz, then the sampling rate for processor 1 is three times the value of processor 3. A sampling rate for processor 2 is 3/2 the value of processor 3.

Alternatively, while the 1:2:3 ratio is active, every sample in processor 1 may be multiplied by six, processor 2 may be multiplied by three, and processor 3 may be multiplied by two to compensate for the different frequencies. In reports that identify where time spent, or in this case, where performance monitor events occur, typically some type of identification of frequency of events by routine with percentages of occurrences is utilized. By applying weighting techniques, a change in the reports is made to reflect the weightings in the illustrative examples.

In this manner, the different aspects of the present invention take into account frequency changes that may occur in different processors. The example illustrated in FIG. 3 only shows two processors. The different aspects of the present invention may be applied to other numbers of processors other than just two processors. When the frequency of a processor is about to go to zero, a frequency change record is generated in these examples. Alternatively, no trace record indicating that the frequency is about to change to zero may be recorded; however, in this case, there must be a frequency change trace record issued when the frequency changes to a non-zero value. In this case, there are no samples taken and thus no records recorded during the time the frequency is zero. Since there are no records, there is no need to prorate or adjust anything. In either case, a trace record indicating the new frequency may be recorded when the processor has a non-zero frequency.

Turning now to FIG. 4, an example trace is depicted in accordance with an illustrative embodiment of the present invention. In this example, trace 400 and trace 402 are depicted. These are traces, such as trace 316 and 318 in FIG. 3. Trace 400 contains trace records 404, 406, 408, 410 and 412. Trace 402 contains trace records 414, 416,418, 420, and 422. Each of these groupings of trace records may contain one or more trace records. These trace records may be generated every time an interrupt indicating that an event has occurred or the trace records may represent a sampling of the actual events occurring in the processor, depending on the particular implementation.

Each time an interrupt occurs in which a processor frequency changes, a frequency change record is generated and placed into each of the traces. As a result, the same frequency change record shows up in trace 400 and trace 402 even if the frequency change was generated for the processor associated with trace 400. Frequency change record 424 is located between trace records 404 and 406 and between trace records 414 and 416. Frequency change record 426 is located between trace records 406 and 408 and trace records 416 and 418. Frequency change record 428 is located between trace records 408 and 410 and trace records 418 and 420. Frequency change record 430 is located between trace records 410 and 412 and between trace records 420 and 422.

These frequency change records are generated when a frequency change occurs for the processor for which trace 400 is created.

As an example, a performance tool, such as performance tool 320 in FIG. 3, identifies all of the frequency records present in the traces. In these examples, the frequency change records are frequency change records 424, 426, 428, and 430.

In these examples, the frequency change records contain the frequency and cycle count for all of the processors at the time frequency change record 424 is generated. Time is determined by multiplying the frequency by the cycle count of the processor associated with the base trace. Elapsed time is determined by taking the difference between two times. As an example, at frequency change record 426, the trace record in trace 402 has a cycle time, Cy2 and in trace 400 has a cycle time, Cx2. Similarly, at frequency change record 424 in trace 402 has a cycle time, Cy1 and in trace 400 has a cycle time, Cx1. The elapsed time for trace 402 between frequency change records 424 and 426 is (Cy2−Cy1)×frequency in frequency change record 424. In trace 400, the same elapsed time between frequency change records 424 and 426 is used, but the frequency is determined by elapsed time divided by (Cx2−Cx1). By identifying elapsed time, the actual frequency of trace records may be identified to determine which records to select for use in analysis. When calculating the time for records in trace 402, the start time may be initialized to the Cx1 cycles representing the start of the trace on that processor multiplied times the frequency of this base processor. When calculating the time for records in trace 400, the start time at frequency change record 424 is initialized to the same start time as in frequency change record 424 in trace 402. The difference between the start cycles in traces 400 and 402 is used to offset the cycle value in trace 400. For each trace record in trace records 406, the offset from frequency change record 424 in trace 402 is added to the cycle's value in the trace record and is multiplied by the calculated frequency to determine the elapsed time.

The frequency change may be indicated by the hardware and only occur by the hardware on the processor for which it is occurring. However, the interrupt handler uses the Interprocessor Interrupt (IPI) mechanism to cause records to be written on the other processors. Alternatively, the operating system may initiate the frequency change and it would use the IPI mechanism to cause the notification to all the processors.

In embodiments that adjust the usage of records when the traces have been completed, the performance tool first identifies the frequencies of the processors at the beginning of the trace. In one embodiment, the number of specific events between frequency changes is determined for each processor. Using this information, the same number of samples may be chosen from each processor. For example if 100 events occurred on processor 1 and 200 events occur on processor 2, then all the events on processor 1 may be used, but only every other event is used from processor 2. Based on the expected frequency during post processing, the performance tools can determine the actual frequency of events based on the contents of the trace and can determine the elapsed time by knowing the frequency and the cycle count. This information may be employed to select trace records to use or to prorate the usage of the records of events for a particular type of event using this information. The performance tool selects a sample out of so many samples up to the first frequency change record, frequency change record 424. For example, for trace 400, the processor frequency for this trace and type of event may result in an occurrence of 100,000 events per second. In other words, 100,000 trace records per second are generated for trace 400. For trace 402, the processor frequency for the same type of event may result in 10,000 events per second occurring. As a result, 10,000 trace records are generated every second for trace 402. If the desired sampling rate is 100 samples per second, then the performance tool selects one record from every 1,000 records in trace records 404. In other words, the performance tool selects the first trace records from trace records 404 and then skips 999 trace records and then selects a trace record skips, skips 999 trace records, and then selects another trace record from trace records 404. This selection of trace records occurs until frequency change record 424 is encountered. With respect to trace 402, if the processor frequency for this processor results in 10,000 events per second, then one trace record is selected for every 100 trace records in a fashion similar to that described with respect to trace 400. This selection of records for processing occurs until frequency change record 424 is encountered.

In these examples, the identification of the elapsed time and the identification of the real frequency for a set of records occur in response to events. These events are the beginning of a trace, a frequency change record, and the end of a trace in these examples. Only two traces are illustrated in FIG. 4 to more clearly explain the different processes and features in the illustrative examples. Of course, the same process may be applied to sets of traces greater than two. In these examples, each cycle stamp is converted to time value, such as, elapsed time from the beginning of the trace.

With reference now to FIG. 5, a diagram illustrating a frequency change record is depicted in accordance with an illustrative embodiment of the present invention. Frequency change record 500 is an example of a trace record, such as frequency change record 424 in FIG. 4. In this example, frequency change record 500 contains processor identification 502, frequency 504 and cycle count 506. These fields are for one particular processor. Processor identification may be implicit, especially if each processor gets an interrupt. Additionally, frequency change record 500 also contains processor identification 508, frequency 510, and cycle count 512. These fields are for another processor that is present. Frequency change record 500 contains processor identification, frequency, and cycle count for each processor present in the data processing system.

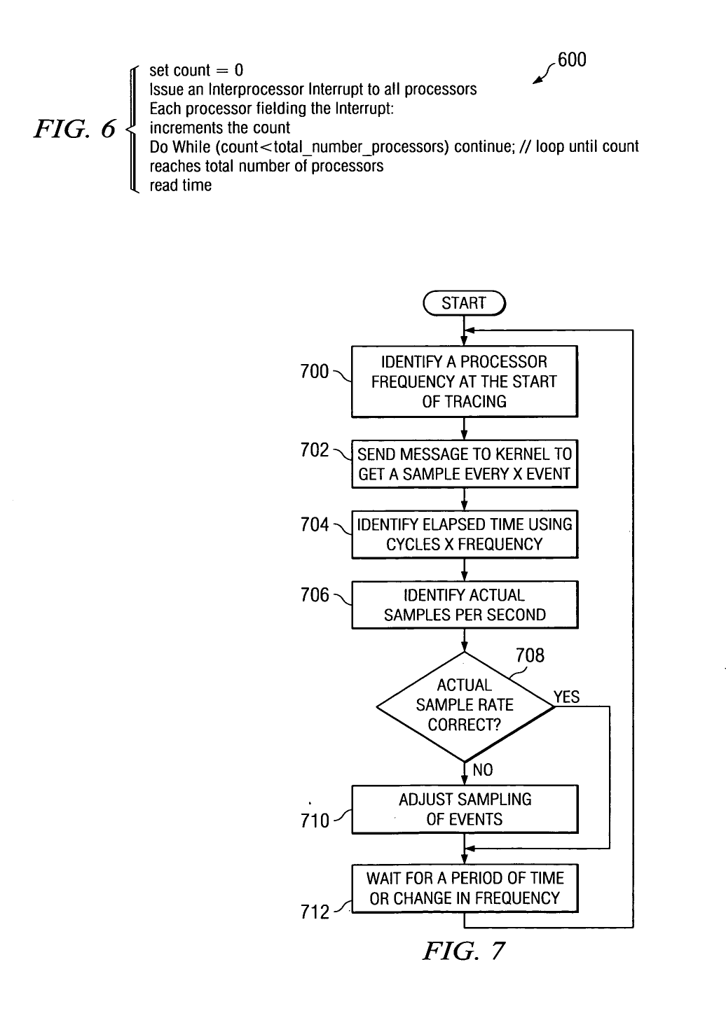

Turning now to FIG. 6, a diagram for pseudo code for reading elapsed time simultaneously on processors is depicted in accordance with an illustrative embodiment of the present invention. In this example, code 600 is an example of code for a process used to issue an interprocessor interrupt to processors within a data processing system. This process may be implemented in a system kernel, a kernel extension, or device driver. The information obtained from this process is used to generate frequency change records such as those described above.

With reference now to FIG. 7, a flowchart of a process for adjusting samples taken during the execution of code is depicted in accordance with an illustrative embodiment of the present invention. The process illustrated in FIG. 7 may be implemented in a performance tool, such as performance tool 320 in FIG. 3.

The process begins by identifying the frequency for each processor at the start of tracing (step 700). Thereafter, a message is sent to the kernel to obtain a sample every x events (step 702). Step 702 may be implemented by using a call to the kernel. The sampling rate may be first identified using a statistical database to identify the expected samples per second for the frequency of the processor. A higher sampling rate may be used to ensure that a sufficient number of samples are obtained initially. The performance tool adjusts the number of occurrences up or down to match the requested rate. For example, the performance tool might start out obtaining an interrupt on every occurrence and then, depending upon the elapsed time, the performance tool adjusts the number of occurrences to match the requested rate.

Thereafter, the elapsed time is identified using cycles and frequencies (step 704). This information is obtained from the samples of events that are placed into the trace buffer. The number of cycles between samples and the frequency of the processor are used to identify the elapsed time. Then, the actual samples per second are identified using the elapsed time (step 706). Elapsed time is determined by using the frequency of the processor and the cycles and the number of trace records is determined by counting the records. Note that each record is time stamped using cycles. A determination is then made as to whether the actual sampling rate is correct (step 708). This actual sampling rate is compared to the desired sampling rate. If the actual sampling rate is incorrect, the process adjusts the sampling of events upwards or downwards in frequency to reach the desired sampling rate (step 710).

The process then waits for a period of time or for a change in frequency to occur (step 712). Upon one of these events occurring, the process returns to step 700 as described above.

Returning to step 708, if the actual sampling rate is correct, the process proceeds to step 712 as described above. In this manner, the sampling of events may be adjusted during tracing to obtain the desired sampling rate for the trace. This process is performed for each processor generating a trace in these examples. In particular, the process illustrated in FIG. 7 may be run concurrently using different threads in the performance tool.

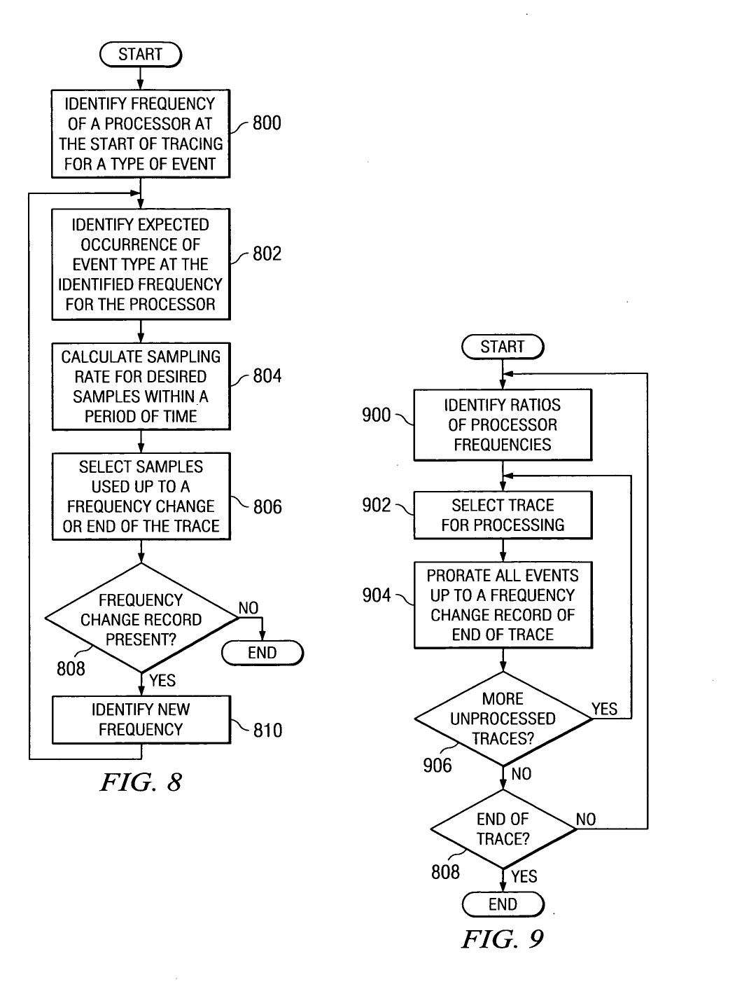

With reference now to FIG. 8, a flowchart of a process used to adjust sampling of events from completed traces is depicted in accordance with an illustrative embodiment of the present invention. The process illustrated in FIG. 8 may be implemented in a performance tool, such as performance tool 320 in FIG. 3.

The process begins by identifying the frequency of a processor at the start of tracing for an event type (step 800). The expected occurrence of the type of event is identified for the frequency for the processor (step 802). This identification is made using statistical information such as that found in statistical database 322 in FIG. 3. The expected occurrence of the event is an event per second in these examples. This information is identified through the frequency of the processor and the event type. Next, the process calculates the sampling rate needed for the desired samples within a period of time (step 804). The desired sample within a period of time is the desired sampling rate. The process then selects samples for use in analysis in a trace up to encountering a frequency change record or the end of the trace (step 806). In these examples, the samples selected in step 806 are the records generated for the events.

Next, a determination is made as to whether a frequency change record has been encountered (step 808). If a frequency change record has been encountered, the process identifies the new frequency (step 810) with the process then returning to step 802. Otherwise, the process terminates. This process is performed for each trace to obtain a uniform sampling rate of events throughout all of the traces for different frequencies of the processors. As a result, different frequencies between different processors are taken into account in addition to changes in frequency during the creation of the trace.

With reference to FIG. 9, a flowchart of a process for prorating events after the completion of a trace is depicted in accordance with an illustrative embodiment of the present invention. The process illustrated in FIG. 9 may be implemented in a performance tool, such as performance tool 320 in FIG. 3.

The process begins by identifying the ratio of processor frequency (step 900). Thereafter, the process selects a trace for processing (step 902). All events are prorated in a frequency change record (step 904). Next, a determination is made as to whether more unprocessed traces are present (step 906). If additional unprocessed traces are present, an unprocessed trace is selected for processing in step 902.

Otherwise, a determination is made as to whether the end of trace has been reached (step 808). If the end of the trace has been reached, the process terminates. Otherwise, the process returns to step 900 to identify the ratios of processor frequencies for the next group of records with the new frequency. With this process, a sample may be weighted, such as, 0.5, 1, 3, or 4.2 depending on the ratio of the frequency for the sample with respect to the frequency of other processors.

Thus, the aspects of the present invention provide an improved computer implemented method, apparatus, and computer usable program code for automatically adjusting profiling rates with variable processor frequencies. The different aspects of the present invention may be applied during the actual generation of the trace or after the trace has been generated. The mechanism of the present invention may adjust the sampling or adjust the weighting of samples depending on the particular implementation. In this manner, the analysis of the different trace records may be given equal weight and are not skewed by changes in processor frequencies.

Further, the illustrated examples are depicted for processing traces in which one type of event is present in each trace. Different traces may have different types of events. The examples assume that the same type of event is present throughout a single trace. The different embodiments of the present invention also may be applied to a single processor in which frequency changes occur during execution of code. The different aspects of the present invention may be applied to adjust for frequency changes or sampling rate changes in a single processor system.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for adjusting rates at which events are sampled, the computer implemented method comprising:
responsive to a frequency change in a processor, identifying a frequency for the processor; and
adjusting a rate at which samples of events generated by the processor are selected to meet a desired rate of sampling in response to identifying the frequency change for the processor to form an adjusted rate.

2. The computer implemented method of claim 1 further comprising:
selecting the samples using the adjusted rate to obtain a trace that is compensated for frequency changes.

3. The computer implemented method of claim 2, wherein the selecting step comprises:
selecting a sample after a selected number of samples in the trace; and
repeating the selecting step until an end of the trace is encountered.

4. The computer implemented method of claim 3 further comprising:
identifying the frequency change from a frequency change record in the trace.

5. The computer implemented method of claim 1, wherein the adjusting step comprising:
determining an expected number of events per period of time;
identifying an actual number of events per period of time based on the trace; and
adjusting the selected number of samples such that the sample is selected at the desired rate of sampling.

6. The computer implemented method of claim 5, wherein the identifying step comprises:
using a number of elapse cycles and the frequency from the trace to calculate the actual number of events per period of time.

7. The computer implemented method of claim 1, wherein the adjusting step and the selecting step are performed during generation of the samples of the events.

8. The computer implemented method of claim 1, wherein the identifying step and the adjusting step are performed by a performance tool.

9. A computer implemented method for adjusting rates at which events are sampled, the computer implemented method comprising:
responsive to a frequency change in a plurality of processors, identifying frequencies for the plurality of processors;
identifying a ratio of the frequencies for the plurality of processors, wherein a processor weight is associated with each processor in the plurality of processors; and
adjusting a weight for each sample in a trace associated with a processor from the frequency change to a next frequency change based on a particular processor weight associated with the processor.

10. The computer implemented method of claim 9 further comprising:
responsive to the next frequency change in a plurality of processors, identifying new frequencies for the plurality of processors;
identifying a new ratio of the frequencies for the plurality of processors, wherein a new processor weight is associated with each processor in the plurality of processors; and
adjusting the weight for each sample in a trace associated with the processor from the next frequency change to a subsequent frequency change based on a new processor weight associated with the processor.

11. A computer program product comprising:
a computer usable medium having computer usable program code for adjusting rates at which events are sampled, said computer program product including:
computer usable program code, responsive to a frequency change in a processor, for identifying a frequency for the processor; and
computer usable program code for adjusting a rate at which samples of events generated by the processor are selected to meet a desired rate of sampling in response to identifying the frequency change for the processor to form an adjusted rate.

12. The computer program product of claim 11 further comprising:
computer usable program code for selecting the samples using the adjusted rate to obtain a trace that is compensated for frequency changes.

13. The computer program product of claim 12, wherein the computer usable program code for selecting the samples using the adjusted rate to obtain a trace that is compensated for frequency changes comprises:
computer usable program code for selecting a sample after a selected number of samples in the trace; and
computer usable program code for repeating the selecting step until an end of the trace is encountered.

14. The computer program product of claim 13 further comprising:
computer usable program code for identifying the frequency change from a frequency change record in the trace.

15. The computer program product of claim 12, wherein the computer usable program code for adjusting a rate at which samples of events generated by the processor are selected to meet a desired rate of sampling in response to identifying the frequency change for the processor to form an adjusted rate comprising:
computer usable program code for determining an expected number of events per period of time;
computer usable program code for identifying an actual number of events per period of time based on the trace; and
computer usable program code for adjusting the selected number of samples such that the sample is selected at the desired rate of sampling.

16. The computer program product of claim 15, wherein the computer usable program code for identifying an actual number of events per period of time based on the trace comprises:
computer usable program code for using a number of elapse cycles and the frequency from the trace to calculate the actual number of events per period of time.

17. The computer program product of claim 12, wherein the computer usable program code for adjusting a rate at which samples of events generated by the processor are selected to meet a desired rate of sampling in response to identifying the frequency change for the processor to form an adjusted rate and the computer usable program code for selecting the samples using the adjusted rate to obtain a trace that is compensated for frequency changes are executed during generation of the samples of the events.

18. A data processing system comprising:
a bus;
a communications unit connected to the bus;
a memory connected to the bus, wherein the storage device includes a set of computer usable program code; and
a processor unit connected to the bus, wherein the processor unit executes the set of computer usable program code to identify a frequency for the processor in response to a frequency change in a processor and adjust a rate at which samples of events generated by the processor are selected to meet a desired rate of sampling in response to identifying the frequency change for the processor to form an adjusted rate.

19. The data processing system of claim 18, wherein the processor unit further executes the computer usable program code to select the samples using the adjusted rate to obtain a trace that is compensated for frequency changes.

20. The data processing system of claim 18, wherein the processor unit further executes the computer usable program code to select a sample after a selected number of samples in the trace and repeat the selecting step until an end of the trace is encountered.
